(19) United States
(12) Patent Application Publication
(10) Pub. No.: US 2025/0294632 A1
(43) Pub. Date: Sep. 18, 2025

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Hiroshi SHIBATA, Yatomi (JP)

(21) Appl. No.: 19/078,801

(22) Filed: Mar. 13, 2025

(30) Foreign Application Priority Data
Mar. 15, 2024 (JP) 2024-041385

(51) Int. Cl. H04W 76/15; H04W 8/00; H04W 92/10

(52) U.S. Cl. CPC H04W 76/15; H04W 8/005; H04W 92/10

(57) ABSTRACT

A communication device may include a wireless interface configured to communicate according to a first wireless communication scheme, a second wireless communication scheme, and a third wireless communication scheme. The communication device may establish a first wireless connection with an access point via the wireless interface according to the first wireless communication scheme and execute a search process via the wireless interface. The search process may include: under a first situation, execute a first search process using a first communication channel according to the second wireless communication scheme and a second search process using the first communication channel according to the third wireless communication scheme; and under a second situation, execute a third search process using a second communication channel according to the second wireless communication scheme and a fourth search process using a third communication channel according to the third wireless communication scheme.

### REFERENCE TO RELATED APPLICATION

This application claims priority to Japanese Patent Application No. 2024-041385 filed on Mar. 15, 2024. The entire content of the priority application is incorporated herein by reference.

### BACKGROUND ART

A system comprising a plurality of NAN devices and an access point is known. In a case where a first NAN device is executing communication according to a communication standard other than a Wi-Fi NAN standard, the first NAN device establishes a NAN data link by using a same operation channel as the operation channel of such communication. Contrary to this, in a case where the first NAN device is not executing the communication according to a communication standard other than the Wi-Fi NAN standard, the first NAN device establishes a NAN data link by using an operation channel in which the first NAN device is capable of operating.

### SUMMARY

In the above known system, no consideration is given to switching of operation channels of a NAN device according to whether a wireless connection is established (i.e., is present) between the NAN device and an access point or not.

The present teachings provide an art configured to allow switching communication channels used for a search process according to whether a first wireless connection is established between a communication device and an access point.

The present teachings disclose a communication device. The communication device may comprise: a wireless interface configured to communicate according to a first wireless communication scheme, a second wireless communication scheme, and a third wireless communication scheme; and a controller configured to: establish a first wireless connection with an access point via the wireless interface according to the first wireless communication scheme; and execute a search process for searching for an external device via the wireless interface, wherein the search process includes: under a first situation where the first wireless connection with the access point is established, execute a first search process using a first communication channel according to the second wireless communication scheme and a second search process using the first communication channel according to the third wireless communication scheme; and under a second situation where the first wireless connection with the access point is not established, execute a third search process using a second communication channel according to the second wireless communication scheme and a fourth search process using a third communication channel different from the second communication channel according to the third wireless communication scheme.

According to the above configuration, the communication device executes the first and second search processes both using the same communication channel under the first situation, and executes the third and fourth search processes using the different communication channels under the second situation. According to such configuration, depending on whether the first wireless connection is established between the communication device and the access point, the communication channels used for the search process can be appropriately switched.

A non-transitory computer-readable recording medium storing computer-readable instructions for realizing the above-described communication device, and a method executed by the above-described communication device are also novel and useful. Also, a communication system comprising a communication device, an access point, and an external device is novel and useful.

### BRIEF DESCRIPTION OF DRAWINGS

FIG. 1 illustrates a configuration of a communication system.

FIG. 2 illustrates an example of channel tables.

FIG. 3 illustrates a sequence diagram of Case A.

FIG. 4 illustrates transition of communication channels in Case B.

FIG. 5 illustrates transition of communication channels in Case C.

FIG. 6 illustrates transition of communication channels in Case D.

FIG. 7 illustrates transition of communication channels in Case E.

FIG. 8 illustrates transition of communication channels in Case F.

### DESCRIPTION

### First Embodiment

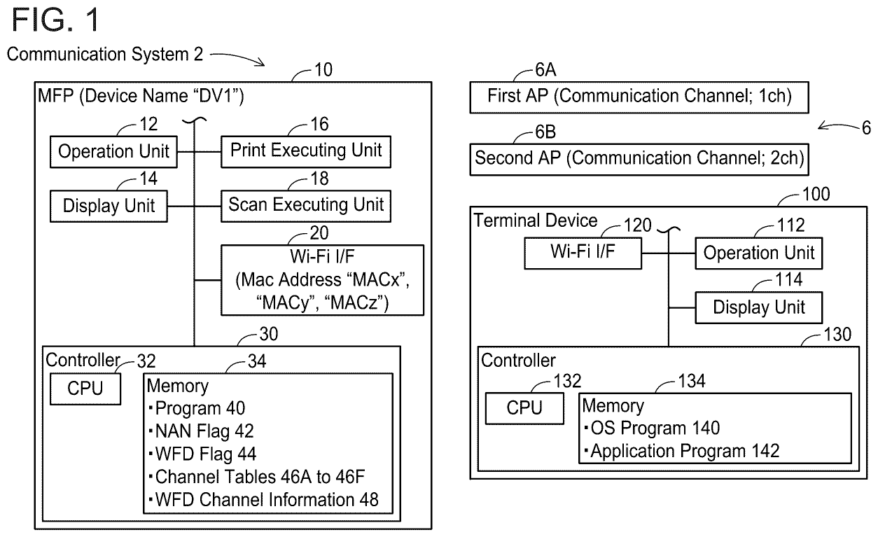

### Configuration of Communication System 2; FIG. 1

As illustrated in FIG. 1, a communication system 2 comprises an MFP 10, a terminal device 100, a first access point 6A, and a second access point 6B. Hereafter, an access point will be termed “AP”. In the present embodiment, the first AP 6A uses as 1ch in 2.4 GHz band as its communication channel, whereas the second AP 6B uses 2ch in 2.4 GHz band as its communication channel. Hereafter, the first AP 6A and the second AP 6B may be collectively termed “AP 6”.

### Configuration of MFP 10

The MFP 10 is a peripheral device configured to execute a print function and a scan function (i.e., peripheral device for a PC, for example). The MFP 10 has a device name “DV1”. The device name is a name given by an administrator of the MFP. The MFP 10 comprises an operation unit 12, a display unit 14, a print executing unit 16, a scan executing unit 18, and a Wi-Fi interface 20. Hereafter, an interface will be termed “I/F”.

The operation unit 12 is an I/F which enables a user to input various information to the MFP 10. The operation unit 12 includes, for example, a touch panel for displaying software key(s) (operation object(s)), hardware key(s), or both of them. The hardware key(s) include, for example, button(s) and/or switch(es). The display unit 14 is a display or a panel for displaying various information. The display is for example a liquid crystal display or an organic EL display. The panel may or may not be a touch panel. Also, the panel is for example a liquid crystal panel, or an organic EL panel.

The print executing unit 16 includes a print engine of inkjet scheme, electrophotographic scheme, or thermal scheme. The print engine of inkjet scheme includes a print head that ejects ink droplets. The print engine of electrophotographic system includes a photoreceptor and an exposure device that exposes the photoreceptor by emitting light. The print engine of thermal scheme includes a print head that emits heat with a heater. The scan executing unit 18 comprises for example a scan mechanism such as CIS, CCD.

The Wi-Fi I/F 20 is a wireless interface for executing wireless communication according to a Wi-Fi scheme. The Wi-Fi scheme is a wireless communication scheme for executing wireless communication according to for example a 802.11 standard of the Institute of Electrical and Electronics Engineers, Inc. (IEEE) and its subordinate standards (e.g., 802.11a, 11b, 11g, 11n, 11ac, 11ad, 11ax). A frequency of a carrier wave in the wireless communication according to the Wi-Fi scheme is for example 1.0 GHz band, 2.4 GHz band, 5.0 GHz band, or 6.0 GHz band. In the present embodiment, a 2.4 GHz band is used. The MFP 10 is configured to establish a wireless connection with the AP 6 via the Wi-Fi I/F 20 by using a Service Set Identifier (SSID) and a password of a wireless network formed by the AP 6. Hereafter, a wireless communication scheme for establishing a wireless connection between the MFP 10 and the AP 6 will be termed “normal Wi-Fi scheme”. Also, a wireless connection established between the MFP 10 and the AP 6 will be termed “AP connection”. The Wi-Fi I/F 20 is assigned a MAC address “MACx” as a MAC address corresponding to the normal Wi-Fi scheme.

The Wi-Fi I/F 20 supports a Wi-Fi Aware scheme formulated by Wi-Fi Alliance. Wi-Fi Aware is also called Wi-Fi Neighbor Awareness Network (NAN). Hereafter, Wi-Fi Aware will be termed “NAN”. The NAN scheme is a communication scheme written in a specification “Wi-Fi Aware Specification Version 4.0” created by Wi-Fi Alliance. Hereafter, a wireless connection established according to the NAN scheme will be termed “NAN connection”.

A device capable of operating according to the NAN scheme can join a NAN cluster. Each device joining the NAN cluster is assigned one of roles, i.e., Master, Anchor Master, and Non-Master. Master is capable of executing sharing of timer information, service search, and enticement to the NAN cluster. Anchor Master is capable of executing setting of the timer information for synchronization in addition to the functions the Master is capable of executing. Non-Master is capable of executing the sharing of the timer information and the service search, but incapable of executing the enticement to the cluster. The Wi-Fi I/F 20 is assigned a MAC address “MACy” as the MAC address corresponding to the NAN scheme.

The Wi-Fi I/F 20 supports a Wi-Fi Direct (WFD) scheme formulated by Wi-Fi Alliance. Wi-Fi Direct is a registered trademark of Wi-Fi Alliance. The WFD scheme is a wireless communication scheme written in a specification created by Wi-Fi Alliance “Wi-Fi Direct Specification Version 1.9”. Hereafter, a wireless connection established according to the WFD scheme will be termed “WFD connection”. The Wi-Fi I/F 20 is assigned a MAC address “MACz” as the MAC address corresponding to the WFD scheme. A device capable of operating according to the WFD scheme can operate in one of Group Owner (G/O) state, Client (CL) state, and device state under the WFD scheme.

The Wi-Fi I/F 20 can simultaneously establish the AP connection and a WFD connection. The Wi-Fi I/F 20 can simultaneously establish a normal Wi-Fi connection and a NAN connection. On the other hand, the Wi-Fi I/F 20 cannot simultaneously establish the WED connection and the NAN connection.

A controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, a flash memory, a Solid State Drive (SSD), a Hard Disk Drive (HDD), or a combination thereof. A program 40 is stored in the auxiliary storage of the memory 34. The CPU 32 realizes various processes according to a program loaded from the auxiliary storage to the primary storage. In the memory 34, further, a NAN flag 42, a WFD flag 44, channel tables 46A to 46F, WFD channel information 48 are stored. The NAN flag 42 indicates either “ON” meaning that the MFP 10 is in a state operable according to the NAN scheme, or “OFF” meaning that the MFP 10 is in a state not operable according to the NAN scheme. The WFD flag 44 indicates either “ON” meaning that the MFP 10 is in a state operable according to the WFD scheme, or “OFF” meaning that the MFP 10 is in a state not operable according to the WFD scheme. The WFD channel information 48 indicates communication channel(s) available when an external device is searched for according to the WFD scheme. The WFD channel information 48 is information pre-determined by Wi-Fi Alliance. The WFD channel information 48 indicates 1cn, 6ch, 11ch in 2.4 GHz band. That is, the MFP 10 can use selectively one of 1ch, 6ch, 11ch in a first Listen process and a second Listen process to be described later.

### Configuration of Terminal Device 100

The terminal device 100 is a terminal device such as a mobile phone (e.g., smartphone), a PDA, or a tablet PC. The terminal device 100 comprises an operation unit 112, a display unit 114, a Wi-Fi I/F 120, and a controller 130.

The operation unit 112 is a user interface which enables a user to input various information to the terminal device 100. The operation unit 112 includes, for example, a touch panel for displaying software key(s) (operation object(s)), hardware key(s), or a combination thereof. The hardware key(s) include, for example, button(s) and/or switch(es). The display unit 114 is a display or a panel for displaying various information. The display is for example a liquid crystal display or an organic EL display. The panel may or may not be a touch panel. Also, the panel is for example a liquid crystal panel or an organic EL panel. The Wi-Fi I/F 120 has a configuration the same as that of the Wi-Fi I/F 20 of the MFP 10.

The controller 130 comprises a CPU 132 and a memory 134. The memory 134 comprises a primary storage and an auxiliary storage. An OS program 140 and an application program 142 are stored in the auxiliary storage of the memory 134. OS is an abbreviation for Operating System. Hereafter, the OS program 140, the application program 142 will respectively be termed “OS 140” and “app 142”. The OS 140 controls basic operations of the terminal device 100. The app 142 is a program for establishing the NAN connection.

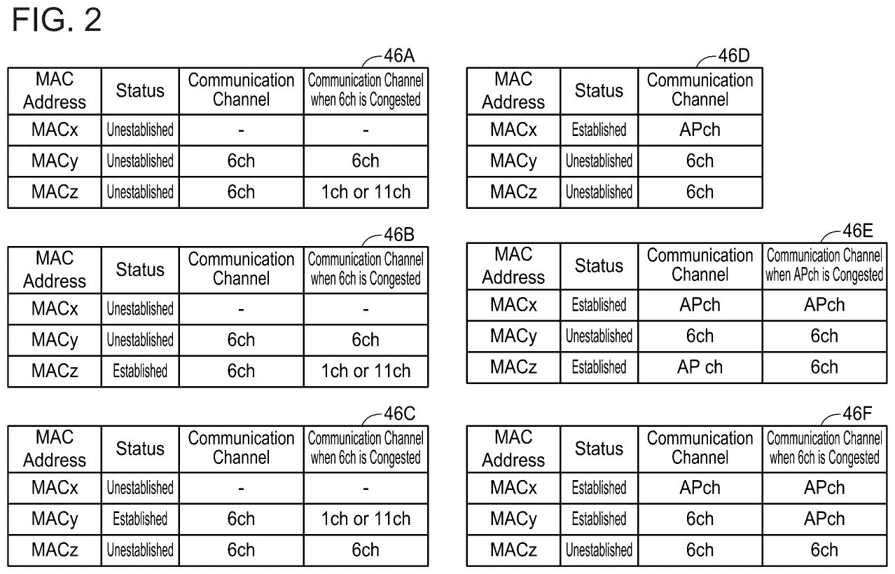

### Configuration of Channel Tables 46A to 46F; FIG. 2

With reference to FIG. 2, contents of the channel tables 46A to 46F of the MFP 10 will be described. The channel tables 46A to 46F are tables for determining a communication channel corresponding to each of the MAC addresses “MACy”, “MACz”. Hereafter, communication channels respectively corresponding to the MAC addresses “MACx”, “MACy”, “MACz” will be termed “AP communication channel”, “NAN communication channel”, “WFD communication channel”.

Each of the channel tables 46A to 46F includes a MAC address, status information, communication channel. The status information indicates either “Unestablished” indicating that a wireless connection using a MAC address corresponding to such information is not established or “Established” indicating that the wireless connection using the MAC address corresponding to such information is established. Each of the channel tables 46A to 46C, 46F further includes a communication channel when 6ch is congested. Here, “when 6ch is congested” means a situation where wireless communication using 6ch is difficult, such as when the number of device(s) existing around the MFP 10 and also using 6ch is equal to or more than a predefined number, and/or when an error percentage of packets received using 6ch is equal to or more than a predefined percentage. Further, the channel table 46E includes a communication channel when AP channel is congested. The AP channel is a communication channel used in the AP connection. The AP channel is a communication channel determined in the AP. Here, the communication channel “1ch or 11ch” in the channel tables 46A to 46C means that one of 1ch and 11ch may be determined as the communication channel. In the present embodiment, in a case where “1ch or 11ch” is determined as the communication channel, the MFP 10 determines 1ch out of 1ch and 11ch as the communication channel.

### Specific Cases

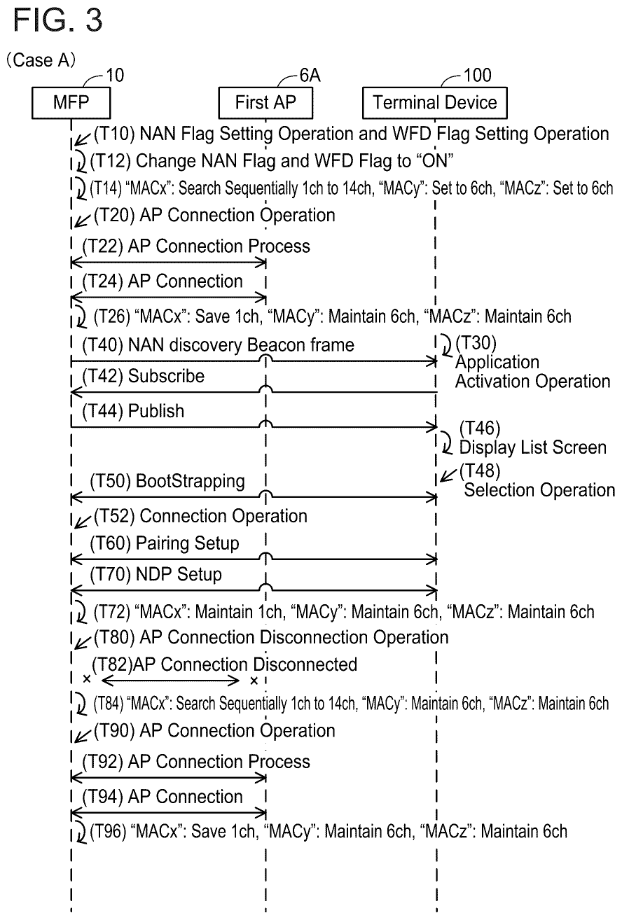

With reference to FIGS. 3 to 8, specific cases realized by the communication system 2 of the present embodiment will be described. Hereafter, all the communication between the MFP 10 and another device is executed via the Wi-Fi I/F 20 of the MFP 10. Accordingly, hereafter, a recitation “via the Wi-Fi I/F 20” will be omitted. Likewise, a process executed by a CPU of each device will be described without describing the respective CPU as a subject of action, but with each device as a subject of action for easier understanding.

### Case A; FIG. 3

With reference to FIG. 3, Case A will be described. At an initial state of Case A, the AP connection, the NAN connection, and the WFD connection are not established. Further, at the initial state of Case A, the NAN flag 42 and the WFD flag 44 of the MFP 10 are set to “OFF”. Due to this, the MFP 10 executes operation according to the normal Wi-Fi scheme but does not execute operation according to the NAN scheme and the WFD scheme. Because the AP connection is not established, the MFP 10 executes a normal search process according to the normal Wi-Fi scheme. The normal search process is a process for searching for an AP. In the normal search process, the MFP 10 causes the Wi-Fi I/F 20 to operate sequentially in 1ch to 14ch in 2.4 GHz.

In T10, the user performs a NAN flag setting operation for setting the NAN flag 42 to “ON” and a WFD flag setting operation for setting the WFD flag 44 to “ON” on the MFP 10. Due to this, in T12, the MFP 10 changes the WFD flag 44 and the NAN flag 42 to “ON”. In response to the NAN flag 42 being changed to “ON”, the MFP 10 results in operating as Master in the NAN scheme. Further, in response to the WFD flag 44 being changed to “ON”, the MFP 10 results in operating as the device state of the WFD scheme. At this occasion, the AP connection, the NAN connection, and the WFD connection are not established. In this case, the MFP 10 determines a NAN communication channel to be used in a NAN search process according to the NAN scheme and a WFD communication channel to be used in a first WFD search process according to the WFD scheme, and sequentially executes the normal search process, a NAN search process, and a first WFD search process. A procedure of determining the NAN communication channel and the WFD communication channel will be described. Firstly, the MFP 10 specifies the channel table 46A in which the status information corresponding to the MAC addresses “MACx”, “MACy”, “MACz” are “Unestablished”, “Unestablished”, and “Unestablished”, respectively. Next, the MFP 10 assesses that 6ch is not congested. Next, the MFP 10 specifies the communication channel “6ch” as a channel corresponding to the NAN communication channel and also as a channel “6ch” corresponding to the WFD communication channel from the channel table 46A. Subsequently, in T14, the MFP 10 sets the NAN communication channel and the WFD communication channel to “6ch”. Due to this, the MFP 10 executes the NAN search process using 6ch and the first WFD search process using the same 6ch. Here, the communication channel available in the NAN search process is preset as 6ch by Wi-Fi Alliance. The NAN search process is a process for searching for a device which can join the NAN cluster. The MFP 10 periodically sends a NAN discovery beacon frame in the NAN search process. Further, the first WFD search process includes a Scan process and a first Listen process. The Scan process is a process for searching for a device in the G/O state by sending a Probe request. In the Scan process, in 2.4 GHz band for example, 1ch to 14ch are sequentially used. The first Listen process is a process for responding to the Probe request sent by another device, and 6ch set in T14 is used in this process. Here, the “Search process” includes both a configuration of searching for an external device in response to the MFP 10 sending a signal to the external device and a configuration of searching for an external device in response to the MFP 10 receiving a signal from the external device.

In T20, the user performs an AP connection operation for establishing the AP connection between the MFP 10 and the first AP 6A on the MFP 10. The AP connection operation includes, for example, an operation of inputting an SSID and a password of the first AP 6A. Due to this, in T22, an AP connection process including, for example, 4way-handshake is executed between the MFP 10 and the first AP 6A, and in T24, the AP connection in which 1ch is used is established between the MFP 10 and the first AP 6A. In this case, in T26, the MFP 10 stores “1ch” as the AP communication channel and maintains the NAN communication channel and the WFD communication channel as “6ch”.

In T30, the user performs an app activation operation for activating the app 142 on the terminal device 100. Due to this, the terminal device 100 activates the app 142. In response to the app 142 being activated, the terminal device 100 operates as Non-Master in the NAN scheme. Due to this, in T40, in the NAN search process, the terminal device 100 receives the NAN discovery beacon frame from the MFP 10 and joins the NAN cluster, and in T42, the terminal device 100 sends Subscribe for inquiring a service which the MFP 10 can provide to the MFP 10.

In T42, when the MFP 10 receives the Subscribe from the terminal device 100, in T44 the MFP 10 sends Publish indicating that the MFP 10 can provide a print service to the terminal device 100.

When in T44 the terminal device 100 receives the Publish from the MFP 10, in T46 the terminal device 100 causes the display unit 114 to display a list screen including the print service corresponding to the MFP 10. In T48, the user performs an operation of selecting the print service corresponding to the MFP 10 on the terminal device 100. Due to this, in T50 Bootstrapping is executed between the MFP 10 and the terminal device 100. Bootstrapping includes, for example, a process of checking connection scheme(s) which each device supports and a process of determining a connection scheme to be used for establishing the NAN connection.

In T52, the user performs a connection operation for establishing the NAN connection between the MFP 10 and the terminal device 100 on the terminal device 100. Due to this, in T60, Pairing Setup is executed between the MFP 10 and the terminal device 100. The Pairing Setup includes, for example, a process of reinforcing encryption according to Simultaneous Authentication of Equals (SAE) scheme. Next, in T70, NDP Setup is executed between the MFP 10 and the terminal device 100. The NDP Setup includes, for example, a process of establishing the NAN connection and a process of determining the NAN communication channel which is a communication channel to be used in the NAN connection. The process of the MFP 10 determining the NAN communication channel will be described. The MFP 10 specifies the channel table 46F in which the status information corresponding to the MAC addresses “MACx”, “MACy”, “MACz” are “Established”, “Established”, and “Unestablished”, respectively. Next, the MFP 10 determines that 6ch is not congested. In this case, the MFP 10 specifies the communication channel “6ch” corresponding to the NAN communication channel from the channel table 46F. Then, in the NDP Setup, the MFP 10 determines 6ch as the NAN communication channel. Due to this, the NAN connection in which 6ch is used is established between the MFP 10 and the terminal device 100. In this case, in T72, the MFP 10 maintains the AP communication channel, the NAN communication channel, and the WFD communication channel respectively as “1ch”, “6ch”, and “6ch”. As such, when the terminal device 100 is found in the NAN search process, the MFP 10 determines to use 6ch in the NAN connection between the MFP 10 and the terminal device 100. According to such configuration, the MFP 10 does not have to switch the NAN communication channels before and after the NAN connection is established.

In T80, the user performs an AP disconnection operation for disconnecting the AP connection between the MFP 10 and the first AP 6A on the MFP 10. Due to this, in T82 the AP connection between the MFP 10 and the first AP 6A is disconnected. In T84, the MFP 10 restarts to execute the normal search process of causing the Wi-Fi I/F 20 to operate sequentially in 1ch to 14ch, and maintains the NAN communication channel and the WFD communication channel as “6ch”.

T90 to T96 are respectively the same as T20 to T26. Due to this, the AP connection is re-established between the MFP 10 and the first AP 6A. In the present case, after the AP connection has been re-established between the MFP 10 and the first AP 6A, the Wi-Fi I/F 20 results in operating in two communication channels. In this case, the MFP 10 does not disconnect the NAN connection.

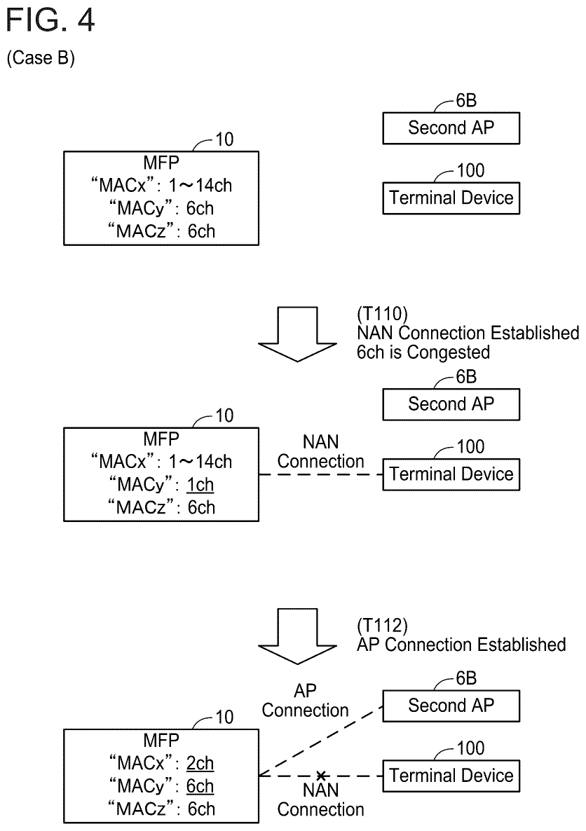

### Case B; FIG. 4

With reference to FIG. 4, Case B will be described. An initial state of Case B is the state after T14 of Case A in FIG. 3. Due to this, the MFP 10 sequentially executes the normal search process, the NAN search process, the first WFD search process.

In T110, the NAN connection is established between the MFP 10 and the terminal device 100. In the present case, a situation where 6ch is congested at a timing when the NAN connection is established will be assumed. The MFP 10 specifies the channel table 46C in which the status information corresponding to the MAC addresses “MACx”, “MACy”, “MACz” are “Unestablished”, “Established”, and “Unestablished”, respectively. Next, the MFP 10 specifies that 6ch is congested. In this case, the MFP 10 specifies the communication channel “1ch” corresponding to the NAN communication channel for the case where 6ch is congested from the channel table 46C. Subsequently, the MFP 10 determines 1ch as the NAN communication channel in the NDP Setup. Then, the MFP 10 sets the NAN communication channel to “1ch”, and maintains the WFD communication channel as “6ch”. As such, in a case where the terminal device 100 is found in the NAN search process, the MFP 10 determines to use 1ch in the NAN connection between the MFP 10 and the terminal device 100. According to such configuration, since the MFP 10 uses a suitable communication channel, the following situations, such as not suitably receiving a signal related to wireless communication, delay in wireless communication, decrease in communication speed of wireless communication, can be suppressed.

In T112, the AP connection in which 2ch is used is established between the MFP 10 and the second AP 6B. In this case, the AP communication channel, the NAN communication channel, and the WFD communication channel are “2ch”, “1ch”, and “6ch”, respectively. That is, the Wi-Fi I/F 20 results in operating in three communication channels. In a case where three communication channels are used, as compared to the configuration where two communication channels are used, time which the Wi-Fi I/F 20 operates in each communication channel is shorter. For this reason, a possibility of the Wi-Fi I/F 20 receiving a signal corresponding to each communication channel decreases. To address this situation, in a case where the MFP 10 assesses that the Wi-Fi I/F 20 operates in three communication channels, the MFP 10 executes a process of causing the Wi-Fi I/F 20 to operate in two communication channels. Specifically, the MFP 10 executes a process of disconnecting the NAN connection with the terminal device 100. Next, the MFP 10 specifies the channel table 46D in which the status information respectively corresponding to the MAC addresses “MACx”, “MACy”, “MACz” are “Established”, “Unestablished”, and “Unestablished”. Next, the MFP 10 specifies the communication channel “6ch” as a channel corresponding to each of the NAN communication channel and the WFD communication channel from the channel table 46D. Then, the MFP 10 stores “2ch” as the AP communication channel, sets the NAN communication channel to “6ch”, and maintains the WFD communication channel as “6ch”. Due to this, the Wi-Fi I/F 20 results in operating in two communication channels. As such, in the case where the AP connection with the second AP 6B is established after the NAN connection with the terminal device 100 has been established and also the communication channel used in the AP connection and the communication channel used in the NAN connection are different, the MFP 10 disconnects the NAN connection with the terminal device 100. It is likely that the user is to use the MFP 10 and execute wireless communication using the AP connection rather than the wireless communication using the NAN connection. Accordingly, the Wi-Fi I/F 20 can be suppressed from operating in three communication channels, and a wireless connection with a higher likelihood of being used by the user can be maintained.

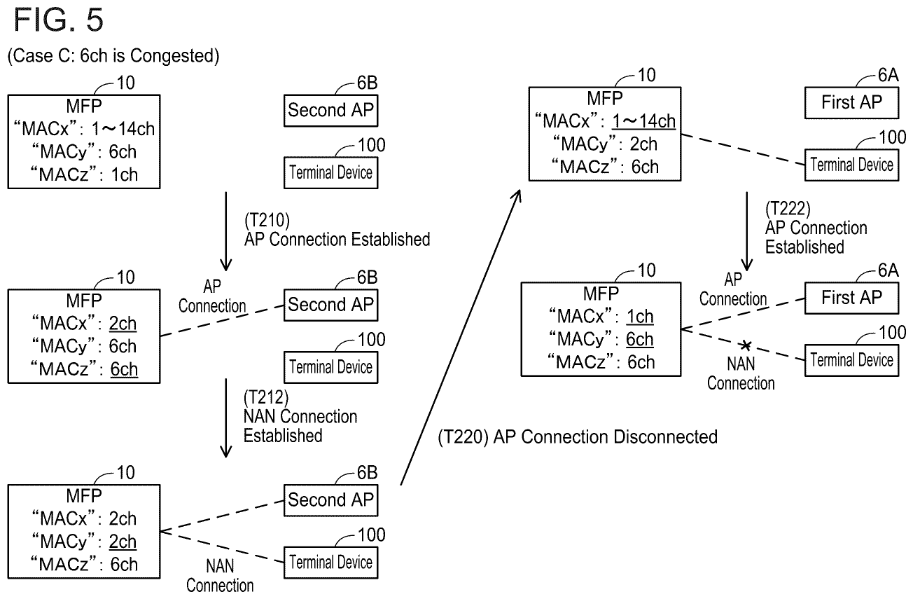

### Case C; FIG. 5

With reference to FIG. 5, Case C will be described. An initial state of Case C is a situation where 6ch becomes congested after T14 of Case A in FIG. 3. In this case, the MFP 10 specifies the channel table 46A in which the statuses corresponding to the MAC addresses “MACx”, “MACy”, “MACz” are “Unestablished”, “Unestablished”, and “Unestablished”, respectively. Next, the MFP 10 assesses that 6ch is congested. Next, the MFP 10 specifies the communication channel “1ch” corresponding to the WFD communication channel for the case where 6ch is congested from the channel table 46A. Subsequently, the MFP 10 maintains the NAN communication channel as “6ch”, and sets the WFD communication channel to “1ch”. Due to this, in this state, the MFP 10 sequentially executes the normal search process according to the normal Wi-Fi scheme, the NAN search process according to the NAN scheme, a second WFD search process according to the WFD scheme. The second WFD search process includes the Scan process and a second Listen process. The second Listen process is the same as the first Listen process except that 1ch is used in the second Listen process.

In T210, the AP connection in which 2ch is used is established between the MFP 10 and the second AP 6B. In this case, the MFP 10 specifies the channel table 46D in which the status information corresponding to the MAC addresses “MACx” “MACy”, “MACz” are “Established”, “Unestablished”, and “Unestablished”, respectively. Next, the MFP 10 specifies that 6ch is congested. Subsequently, the MFP 10 specifies the communication channel “6ch” as a channel corresponding to each of the NAN communication channel and the WFD communication channel from the channel table 46D. In this case, the MFP 10 stores “2ch” as the AP communication channel, maintains the NAN communication channel as “6ch”, and sets the WFD communication channel to “6ch”.

In T212, the NAN connection is established between the MFP 10 and the terminal device 100. The MFP 10 specifies the channel table 46F in which the status information respectively corresponding to the MAC addresses “MACx”, “MACy”, “MACz” are “Established”, “Established”, and “Unestablished”, and specifies that 6ch is congested. Next, the MFP 10 specifies the communication channels “APch”, “6ch” respectively corresponding to the MAC addresses “MACy”, “MACz” for the case where 6ch is congested from the channel table 46F. In this case, the MFP 10 determines 2ch corresponding to APch as the NAN communication channel when the MFP 10 establishes the NAN connection with the terminal device 100. Due to this, the MFP 10 maintains the AP communication channel as “2ch”, sets the NAN communication channel to “2ch”, and maintains the WFD communication channel as “6ch”.

In T220, the AP connection between the MFP 10 and the second AP 6B is disconnected. In this case, the MFP 10 re-starts execution of the normal search process. Here, in the state after T220, the communication channel “6ch” corresponding to the NAN communication channel in the channel table 46D and the current NAN communication channel “2ch” are different. The NAN communication channel cannot be changed, however, with the NAN connection established. Due to this, even when the NAN communication channel in the channel table 46D and the current NAN communication channel are different, the NAN communication channel is not changed.

In T222, the AP connection in which 1ch is used is established between the MFP 10 and the first AP 6A. As a result of this, the AP communication channel, the NAN communication channel, and the WFD communication channel are respectively “1ch”, “2ch”, “6ch”. In this case, the MFP 10 assesses that the Wi-Fi I/F 20 operates in three communication channels, and executes the same process as the process after T112 in FIG. 4. Specifically, the MFP 10 executes the process of disconnecting the NAN connection. As a result of this, the MFP 10 stores “1ch” as the AP communication channel, sets the NAN communication channel to “6ch”, and maintains the WFD communication channel as “6ch”. Due to this, the Wi-Fi I/F 20 results in operating in two communication channels.

### Effects of Case A to Case C

As illustrated in Case C, in the case where 6ch is congested with no AP connection established, the MFP 10 executes the NAN search process using the communication channel “6ch” and the second WFD search process using the communication channel “1ch”. On the other hand, as illustrated in Case A in FIG. 3, in the case where 6ch is not congested with no AP connection established, the MFP 10 executes the NAN search process using the communication channel “6ch” and the first WFD search process using the communication channel “6ch”. According to such configuration, according to whether 6ch is congested or not, the communication channel used in the search process can be suitably switched.

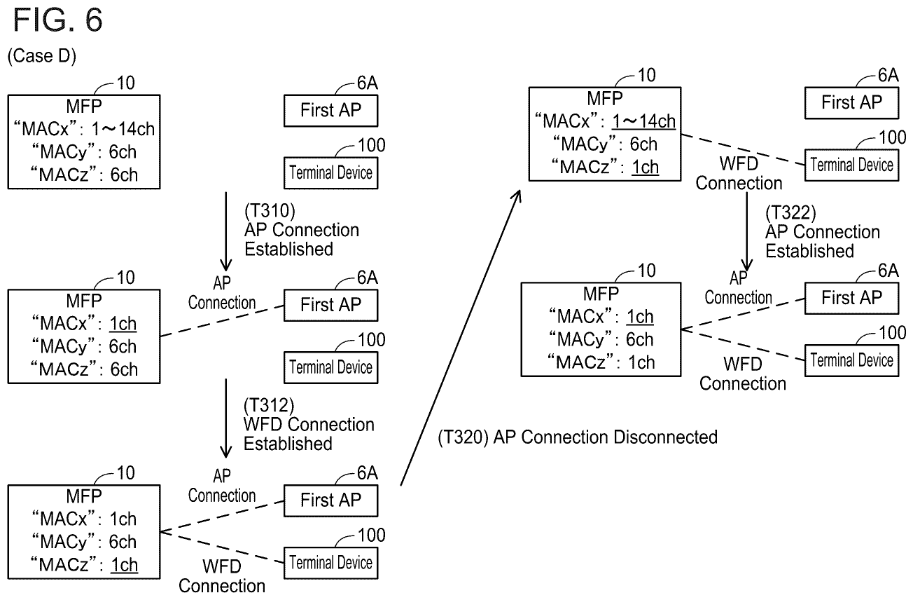

### Case D; FIG. 6

With reference to FIG. 6, Case D will be described. An initial state of Case D is the state after T14 of Case A in FIG. 3. Due to this, the MFP 10 is sequentially executing the normal search process, the NAN search process, and the first WFD search process.

In T310, the AP connection in which 1ch is used is established between the MFP 10 and the first AP 6A. In this case, similar to T26 in FIG. 3, the MFP 10 stores “1ch” as the AP communication channel, and maintains the NAN communication channel and the WFD communication channel as “6ch”.

In T312, the WFD connection is established between the MFP 10 and the terminal device 100. The MFP 10 specifies the channel table 46E in which the status information corresponding to the MAC addresses “MACx”, “MACy”, “MACz” are “Established”, “Unestablished”, and “Established”, respectively. In this case, the MFP 10 specifies the communication channels “6ch”, “APch” respectively corresponding to the NAN communication channel and the WFD communication channel from the channel table 46E. Then the MFP 10 determines 1ch corresponding to APch as the WFD communication channel when the MFP 10 establishes the WFD connection with the terminal device 100. Due to this, the MFP 10 maintains the AP communication channel as “1ch”, maintains the NAN communication channel as “6ch”, and sets the WFD communication channel to “1ch”. As such, the MFP 10 determines to use 1ch in the WFD connection between the MFP 10 and the terminal device 100 when the terminal device 100 is found in the first WFD search process. According to such configuration, since a time during which the Wi-Fi I/20 of the MFP 10 operates in 1ch becomes longer, and thus a chance of success in wireless communication between the MFP 10 and the first AP 6A can be increased.

In T320, the AP connection between the MFP 10 and the first AP 6A is disconnected. In this case, the MFP 10 restarts to execute the normal search process. Here, in the state after T320, the WFD communication channel “6ch” in the channel table 46B and the current WFD communication channel “1ch” are different. The WFD communication channel cannot be changed, however, with the WFD connection established. Due to this, even when the WFD communication channel in the channel table 46B and the current WFD communication channel are different, the WFD communication channel is not changed.

In T322, the AP connection in which 1ch is used is established between the MFP 10 and the first AP 6A. In this case, the MFP 10 stores “1ch” as the AP communication channel, maintains the NAN communication as “6ch”, and maintains the WFD communication channel as “1ch”. In this case, the MFP 10 assesses that the Wi-Fi I/F 20 operates in two communication channels, and does not disconnect the WFD connection between the MFP 10 and the terminal device 100. Since the WFD connection is not disconnected, the user does not have to perform an operation for re-connecting the WFD connection on the MFP 10. Also, since the WFD connection between the MFP 10 and the terminal device 100 is not disconnected, the user can continue to use the wireless communication using the WFD connection.

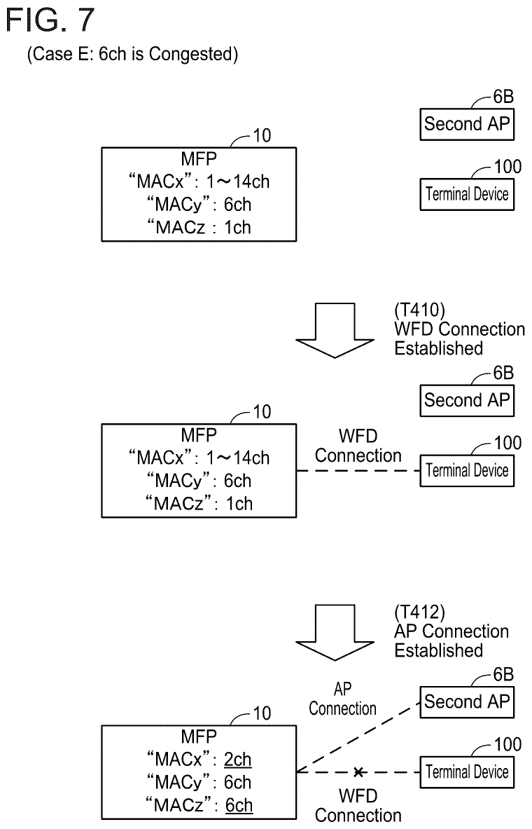

### Case E; FIG. 7

With reference to FIG. 7, Case E will be described. An initial state of Case F is the same as the initial state of Case C in FIG. 5. Due to this, the MFP 10 is sequentially executing the normal search process, the NAN search process, the second WFD search process.

In T410, the WFD connection is established between the MFP 10 and the terminal device 100. The MFP 10 specifies the channel table 46B in which the status information corresponding to the MAC addresses “MACx”, “MACy”, “MACz” are “Unestablished”, “Unestablished”, and “Established”, respectively. Next, the MFP 10 specifies that 6ch is congested. In this case, the MFP 10 specifies the communication channels “6ch”, “1ch” respectively corresponding to the NAN communication channel and the WFD communication channel for the case where 6ch is congested from the channel table 46C. Then, the MFP 10 determines 1ch as the WFD communication channel in the process in which the WFD connection is established. Subsequently, the MFP 10 maintains the NAN communication channel as “6ch”, and maintains the WFD communication channel as “1ch”. As such, the MFP 10 determines to use 1ch in the WFD connection between the MFP 10 and the terminal device 100 when the terminal device 100 is found in the second WFD search process. According to such configuration, the MFP 10 can communicate with the terminal device 100, using a suitable communication channel.

In T412, the AP connection in which 2ch is used is established between the MFP 10 and the second AP 6B. In this case, the AP communication channel, the NAN communication channel, and the WFD communication channel are respectively “2ch”, “6ch”, and “1ch”. That is, the Wi-Fi I/F 20 results in operating in three communication channels. In this case, the MFP 10 executes the process of causing the Wi-Fi I/F 20 to operate in two communication channels. Specifically, the MFP 10 executes the process of disconnecting the WFD connection with the terminal device 100. Next, the MFP 10 specifies the channel table 46D in which the status information corresponding to the MAC addresses “MACx”, “MACy”, “MACz” are “Established”, “Unestablished”, and “Unestablished”, respectively. Subsequently, the MFP 10 specifies the communication channel “6ch” as a channel corresponding to each of the NAN communication channel and the WFD communication channel from the channel table 46D. Subsequently, the MFP 10 stores “2ch” as the AP communication channel, maintains the NAN communication channel as “6ch”, and sets the WFD communication channel to “6ch”. As such, in the case where the AP connection with the second AP 6B is established after the WFD connection with the terminal device 100 has been established and also the communication channel used in the AP connection and the communication channel used in the WFD connection are different, the MFP 10 disconnects the WFD connection with the terminal device 100. It is likely that the user is to use the MFP 10 and execute communication using the AP connection than the communication using the WFD connection. Accordingly, the Wi-Fi I/F 20 can be suppressed from operating in three communication channels, and a wireless connection with a higher likelihood of being used by the user can be maintained.

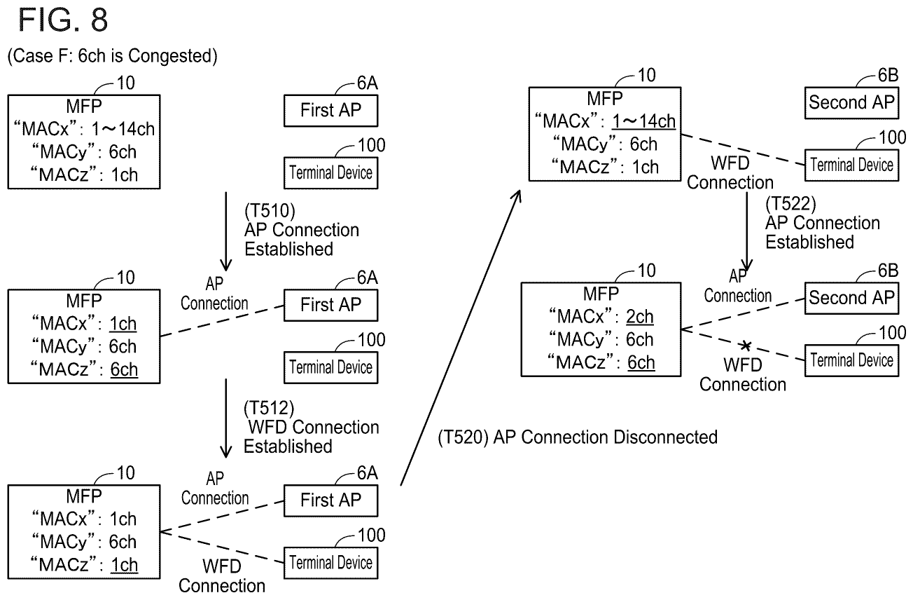

### Case F; FIG. 8

With reference to FIG. 8, Case F will be described. An initial state of Case F is the same as the initial state of Case C in FIG. 5. Due to this, the MFP 10 is sequentially executing the normal search process, the NAN search process, and the second WFD search process.

In T510, the AP connection in which 1ch is used is established between the MFP 10 and the first AP 6A. In this case, the MFP 10 specifies the channel table 46D in which the status information corresponding to the MAC addresses “MACx”, “MACy”, “MACz” are “Established”, “Unestablished”, and “Unestablished”, respectively. Next, the MFP 10 specifies that 6ch is congested. Subsequently, the MFP 10 specifies the communication channel “6ch” as a channel corresponding to each of the NAN communication channel and the WFD communication channel from the channel table 46D. Then, the MFP 10 stores “1ch” as the AP communication channel, maintains the NAN communication channel as “6ch”, and sets the WFD communication channel to “6ch”.

In T512, the WFD connection is established between the MFP 10 and the terminal device 100. The MFP 10 specifies the channel table 46E in which the status information corresponding to the MAC addresses “MACx”, “MACy”, “MACz” are “Established”, “Unestablished”, and “Established”, respectively. Next, the MFP 10 specifies that 6ch is congested. Subsequently, the MFP 10 specifies the communication channels “6ch”, “APch” respectively corresponding to the NAN communication channel and the WFD communication channel from the channel table 46E. In this case, when the MFP 10 establishes the WFD connection with the terminal device 100, the MFP 10 determines 6ch as the WFD communication channel. Due to this, the MFP 10 maintains the AP communication channel as “1ch”, maintains the NAN communication channel as “6ch”, and sets the WFD communication channel to “1ch”.

In T520, the AP connection between the MFP 10 and the first AP 6A is disconnected. In this case, the MFP 10 restarts the execution of the normal search process.

In T522, the AP connection in which 2ch is used is established between the MFP 10 and the second AP 6B. Due to this, the AP communication channel, the NAN communication channel, and the WFD communication channel are “2ch”, “6ch”, and “1ch”, respectively. In this case, the MFP 10 assesses that the Wi-Fi I/F 20 is to operate in three communication channels, and executes the same process as the process after T412 in FIG. 7. Specifically, the MFP 10 executes the process of disconnecting the WFD connection. As a result of this, the MFP 10 stores “2ch” as the AP communication channel, maintains the NAN communication channel as “6ch”, and sets the WFD communication channel to “6ch”. Due to this, the Wi-Fi I/F 20 results in operating in two communication channels.

### Effects of Present Embodiment

As mentioned above, under the situation where the AP connection with an AP is established, the MFP 10 executes the NAN search process and the first WFD search process both using the same communication channel “6ch” (Case A in FIG. 3, Case C in FIG. 5, Case D in FIG. 6, Case F in FIG. 8), whereas on the other hand, under the situation where the AP connection with an AP is not established, the MFP 10 executes the NAN search process using the communication channel “6ch”, and uses the communication channel “1ch” to execute the second WFD search process (Case C in FIG. 5, Case F in FIG. 8). According to such configuration, according to whether the AP connection is established between the MFP 10 and an access point or not, a communication channel used in a search process can be suitably switched.

### Correspondence Relationships

The MFP 10 is an example for “communication device”. The normal Wi-Fi scheme is an example for “first wireless communication scheme”. Wi-Fi Aware scheme is an example for “second wireless communication scheme”. The WFD scheme is an example for “third wireless communication scheme”. The Wi-Fi I/F 20 is an example for “wireless interface”. The terminal device 100 is an example for “external device”. The AP connection is an example for “first wireless connection”. The communication channel “6ch” is an example for “first communication channel”. The NAN search process is an example for “first search process”. The first WFD search process is an example for “second search process”. The communication channel “6ch” is an example for “second communication channel”. The NAN search process is an example for “third search process”. The communication channel “1ch” is an example for “third communication channel”. The second WFD search process is an example for “fourth search process”. The second WFD search process is an example for “fifth search process”. The NAN connection is an example for “second wireless connection”. The WFD connection is an example for “third wireless connection”.

T22 in FIG. 3 for example is an example for the process executed by “establish a first wireless connection”. The processes after T26 of Case A in FIG. 3, the processes of the MFP 10 before T210 in FIG. 5 are an example executed by “execute a search process”.

(First Modification) The “communication device” may not be limited to an MFP, but may be a printer having a print function, a scanner having a scanner function, a PC, for example.

(Second Modification) In a case where “1ch or 11ch” is specified as the NAN communication channel or the WFD communication channel from one of the channel tables 46A to 46C, the MFP 10 may determine 11ch as the NAN communication channel or the WFD communication channel. In the present modification, 11ch is an example for “third communication channel”.

(Third Modification) The “first communication channel” and the “second communication channel” may be different. In the present modification, SoftAP scheme formulated by Wi-Fi Alliance is an example for the “second wireless communication scheme”.

(Fourth Modification) The channel table 46A may include the communication channel “6ch” only as the NAN communication channel, and include the communication channel “1ch or 11ch” only as the WFD communication channel. In the present modification, in the case where the AP connection, the NAN connection, and the WFD connection are not established, no matter whether 6ch is congested or not, the MFP 10 determines the communication channel “6ch” as the NAN communication channel, and determines the communication channel “1ch or 11ch” as the WFD communication channel. That is, in the case where the AP connection, the NAN connection, and the WFD connection are not established, the WFD communication channel is not switched according to whether 6ch is congested or not.

(Fifth Modification) In the NDP Setup of T70 in Case A in FIG. 3, the MFP 10 may determine a communication channel different from 6ch as the NAN connection channel. In the present modification, “establish a second wireless connection with the external device via the wireless interface according to the second wireless communication scheme” can be omitted.

(Sixth Modification) In T110 of Case B in FIG. 4, the MFP 10 may determine a communication channel different from 1ch as the NAN connection channel. In the present modification, “establish a second wireless connection with the external device via the wireless interface according to the second wireless communication scheme” can be omitted.

(Seventh Modification) In T112 of Case B in FIG. 4, even in the case where the Wi-Fi I/F 20 is to operate in three communication channels, the MFP 10 may not disconnect the NAN connection. In the present modification, “disconnect the second wireless connection with the external device” can be omitted. Further, in another modification, after T112, the MFP 10 may disconnect the AP connection instead of the NAN connection.

(Eighth Modification) In Case D in FIG. 6, the MFP 10 may determine a communication channel different from APch as the WFD connection channel. In the present modification “establish a third wireless connection” can be omitted.

(Ninth Modification) In T410 of Case E in FIG. 7, the MFP 10 may determine a communication channel different from 1ch as the WFD connection channel. In the present modification “establish a third wireless connection” can be omitted.

(Tenth Modification) In T412 of Case E in FIG. 7, the MFP 10 may not disconnect the WFD connection even in the case where the Wi-Fi I/F 20 is to operate in three communication channels. In the present modification, “disconnect the third wireless connection with the external device” can be omitted. Further, in another modification, after T412, the MFP 10 may disconnect the AP connection instead of the WFD connection.

(Eleventh Modification) In each of the above embodiments, the processes of FIGS. 3 to 8 are realized by software (e.g., program 40, 140, 142), but at least one of these processes may be realized by hardware such as a logic circuitry.

What is claimed is:

1. A communication device comprising:
a wireless interface configured to communicate according to a first wireless communication scheme, a second wireless communication scheme, and a third wireless communication scheme; and
a controller configured to:
establish a first wireless connection with an access point via the wireless interface according to the first wireless communication scheme; and
execute a search process for searching for an external device via the wireless interface,
wherein the search process includes:
under a first situation where the first wireless connection with the access point is established, execute a first search process using a first communication channel according to the second wireless communication scheme and a second search process using the first communication channel according to the third wireless communication scheme; and
under a second situation where the first wireless connection with the access point is not established, execute a third search process using a second communication channel according to the second wireless communication scheme and a fourth search process using a third communication channel different from the second communication channel according to the third wireless communication scheme.

2. The communication device according to claim 1, wherein the first communication channel and the second communication channel are the same as each other.

3. The communication device according to claim 1, wherein the communication device is capable of searching for the external device using one of three preset communication channels according to the third wireless communication scheme in the search process, and
each of the second communication channel and the third communication channel is one of the three preset communication channels.

4. The communication device according to claim 1, wherein, in a case where the second communication channel is congested under the second situation, the third search process and the fourth search process of the search process are executed, and
in a case where the second communication channel is not congested under the second situation, the third search process and a fifth search process using the second communication channel are executed according to the third wireless communication scheme of the search process.

5. The communication device according to claim 1, wherein the second wireless communication scheme is Wi-Fi Aware scheme, and
the third wireless communication scheme is Wi-Fi Direct (Registered Trademark) scheme.

6. The communication device according to claim 1, wherein a communication channel used in the first wireless connection is one of 1ch to 14ch and determined by the access point.

7. The communication device according to claim 1, wherein the controller is further configured to:
in a case where the external device is found by the first search process, establish a second wireless connection with the external device via the wireless interface according to the second wireless communication scheme,
wherein the first communication channel is used in the second wireless connection.

8. The communication device according to claim 4, wherein the controller is further configured to:
in a case where the external device is found by the fifth search process, establish a second wireless connection with the external device via the wireless interface according to the second wireless communication scheme,
wherein the third communication channel is used in the second wireless connection.

9. The communication device according to claim 8, wherein the controller is further configured to:
in a case where the first wireless connection with the access point is established after the second wireless connection with the external device has been established and a communication channel used in the first wireless connection and a communication channel used in the second wireless connection are different, disconnect the second wireless connection with the external device.

10. The communication device according to claim 1, wherein the controller is further configured to:
in a case where the external device is found by the second search process, establish a third wireless connection with the external device via the wireless interface according to the third wireless communication scheme,
wherein a communication channel same as a communication channel used in the first wireless connection is used in the third wireless connection.

11. The communication device according to claim 1, wherein the controller is further configured to:
in a case where the external device is found by the fourth search process, establish a third wireless connection with the external device via the wireless interface according to the third wireless communication scheme,
wherein the third communication channel is used in the third wireless connection.

12. The communication device according to claim 11, wherein the controller is further configured to:
in a case where the first wireless connection with the access point is established after the third wireless connection with the external device has been established and a communication channel used in the first wireless connection and a communication channel used in the third wireless connection are different, disconnect the third wireless connection with the external device.

13. A non-transitory computer-readable recording medium storing computer-readable instructions for a communication device comprising a processor,
wherein the communication device comprises a wireless interface configured to communicate according to a first wireless communication scheme, a second wireless communication scheme, and a third wireless communication scheme,
wherein the computer-readable instructions, when executed by the processor, cause the communication device to:
establish a first wireless connection with an access point via the wireless interface according to the first wireless communication scheme; and
execute a search process for searching for an external device via the wireless interface,
wherein the search process includes:
under a first situation where the first wireless connection with the access point is established, execute a first search process using a first communication channel according to the second wireless communication scheme and a second search process using the first communication channel according to the third wireless communication scheme; and
under a second situation where the first wireless connection with the access point is not established, execute a third search process using a second communication channel according to the second wireless communication scheme and a fourth search process using a third communication channel different from the second communication channel according to the third wireless communication scheme.

14. A method executed by a communication device, wherein the communication device comprises a wireless interface configured to communicate according to a first wireless communication scheme, a second wireless communication scheme, and a third wireless communication scheme,
wherein the method comprises:
establishing a first wireless connection with an access point via the wireless interface according to the first wireless communication scheme; and
executing a search process for searching for an external device via the wireless interface,
wherein the search process includes:
under a first situation where the first wireless connection with the access point is established, execute a first search process using a first communication channel according to the second wireless communication scheme and a second search process using the first communication channel according to the third wireless communication scheme; and
under a second situation where the first wireless connection with the access point is not established, execute a third search process using a second communication channel according to the second wireless communication scheme and a fourth search process using a third communication channel different from the second communication channel according to the third wireless communication scheme.
